(19) United States
(12) Patent Application Publication
(10) Pub. No.: US 2012/0236727 A1
(43) Pub. Date: Sep. 20, 2012

(54) NETWORK INTERFACE TEST DEVICE

(75) Inventors: MING-HUNG CHOU, TAIPEI CITY (TW); CHING-FENG HSIEH, TAIPEI CITY (TW)

(73) Assignee: ASKEY COMPUTER CORP., NEW TAIPEI CITY (TW)

(21) Appl. No.: 13/111,099

(22) Filed: May 19, 2011

(30) Foreign Application Priority Data
Mar. 15, 2011 (TW) 100108708

(51) Int. Cl. H04L 12/26

(52) U.S. Cl. 370/241

(57) ABSTRACT

A network interface test device for testing a plurality of network interfaces of a network apparatus includes a control unit, a first port, a switch unit, and a plurality of second ports. The control unit generates a control signal required for programming a router line in the switch unit. The programmed router line provides a path for switching a signal between the first port and the second ports. A parallel or cross network test can be performed on a test packet signal of an external network test interface at gigabit Ethernet transmission speed for example, using the switching path. Hence, the network interface test device enables a network test to be performed on a plurality of network interfaces by a network test interface.

### CROSS-REFERENCE TO RELATED APPLICATION

This non-provisional application claims priority under 35 U.S.C. §119(a) on Patent Application No(s).100108708 filed in Taiwan, R.O.C. on Mar. 15, 2011, the entire contents of which are hereby incorporated by reference.

### FIELD OF TECHNOLOGY

The present invention relates to network interface test devices, and more particularly, to a plurality of network interface test devices for testing a network apparatus.

### BACKGROUND

At present, the point-to-point data transmission between a client end and a servo end on the Internet is governed by the Internet Protocol (IP). A local area network (LAN) or a wide area network (WAN) provides connection between a plurality of user ends or connection between a plurality of networks by means of devices, such as a hub, an access point (AP), a broadband router, and a router having at least one network interface function.

At present, the Internet Protocol essentially adopts the technical regulations governing Ethernet. The Ethernet technical regulations are set forth in the IEEE 802.3 enacted by Institute of Electrical and Electronics Engineers, setting the rules that cover the connection of the physical layer, electrical signals, and media access layer protocol.

Depending on speed, Ethernet can be further divided into different categories, namely Ethernet (1 Mbit/s), Ethernet (10 Mbit/s), Ethernet (100 Mbit/s), Ethernet (1 Gbit/s), and Ethernet (10 Gbit/s). Ethernet is applicable to different aspects, depending on the speed of Ethernet. For example, Ethernet (1 Mbit/s) is applicable to an office-based or a home-based LAN. By contrast, Ethernet (10 Mbit/s), Ethernet (100 Mbit/s), Ethernet (1 Gbit/s), and Ethernet (10 Gbit/s) are applicable to devices, such as signal relays and exchanges of network connection of a high-capacity backbone network.

In order to enable the aforesaid devices to be used at the client ends well, manufacturers of the aforesaid devices usually conduct a test on the device before the delivery thereof to confirm that the device can operate well. In this regard, a conventional test involves: treating at least one network card installed on a computer as a network test interface; and performing a plugging and unplugging test on multiple network interfaces of the aforesaid devices manually and by means of a network cable. The manually conducted conventional test is laborious and susceptible to inaccuracy.

In view of this, the related prior art discloses inserting at least two network cards onto a plurality of network interfaces, respectively, and conducting tests in turn (i.e., alternate queries). However, alternate queries are time-consuming whenever there are plenty of network interfaces to be tested. Furthermore, alternate queries require a plurality of network cards and an intricate installation line.

Accordingly, it is imperative to put forth an invention for overcoming the drawbacks of the prior art.

### SUMMARY

An objective of the present invention is to provide a network interface test device effective in enabling a single network test interface to automatically switch between multiple network interfaces of a network apparatus so as for a test to be conducted thereon.

Another objective of the present invention is to conduct parallel or cross network tests on multiple network interfaces directly with the aforesaid test device.

Yet another objective of the present invention is to conduct a network test on a programmable switching path by a controlling driving unit and the aforesaid test device.

In order to achieve the above and other objectives, the present invention provides a network interface test device for testing a plurality of network interfaces of a network apparatus. The network interface test device comprises: a control unit for generating a control signal; a first port connected to an external network test interface so as to receive a test packet signal generated by the network test interface; a switch unit connected to the first port and the control unit and equipped with at least one router line switchable to form a switching path according to the control signal; and a plurality of second ports connected to the switch unit and connected to the network interfaces, wherein any one of the second ports is electrically connected to the first port via the switching path to enable the test packet signal to be transmitted by the first port to one of the network interfaces which is selected according to the switching path.

Compared with the prior art, the present invention provides a network interface test device for use with a plurality of network interfaces of a network apparatus, to conduct a test of the transmission of packets conveyed between the network interfaces and an external network test interface by means of a wide area network (WAN) interface in the network interfaces so as to confirm whether the network interfaces meet the speed specifications set forth in IEEE 802.3 Ethernet (10BASE-T Ethernet) and express Ethernet (100BASE-T, 1000BASE-T Ethernet), and to conduct a test of the transmission of packets conveyed between one of the network interfaces and the network interfaces so as to confirm whether the functions of the network interfaces meet the Ethernet specifications.

In addition, a test circuit provided by the present invention enables a plurality of network interfaces to be tested by means of a single network test interface and a plurality of router lines in a switch circuit which is programmable planned such that, with the router lines being planned, the parallel or cross network tests can be easily conducted.

Hence, according to the present invention, a test can be conducted on network interfaces in accordance with express Ethernet specifications, and it is feasible to conduct an express network test stably without losing a packet in the course of the transmission thereof.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a network interface test device according to the first embodiment of the present invention;

FIG. 2 is a schematic view of the network interface test device according to the second embodiment of the present invention; and

FIG. 3 is a circuit diagram of a switch unit of the network interface test device according to the third embodiment of the present invention.

### DETAILED DESCRIPTION

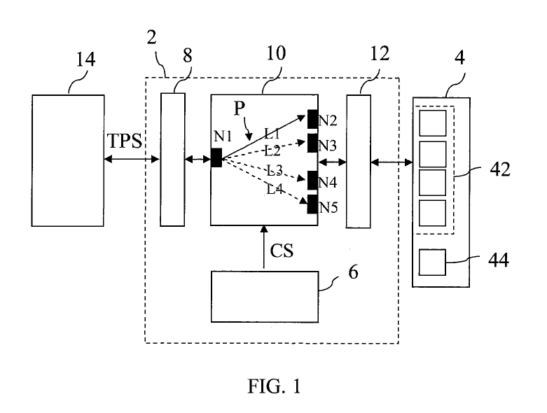

Referring to FIG. 1, there is shown a schematic view of a network interface test device 2 according to the first embodiment of the present invention. As shown in FIG. 1, the network interface test device 2 is adapted for use in testing a plurality of network interfaces of a network apparatus 4. The network interfaces comprise a local area network (LAN) interface 42 and a wide area network (WAN) interface 44 for a distinguishing purpose. The LAN interface 42 refers to a network that covers local areas, such as homes, offices, or areas between different levels of a building. The WAN interface 44 refers to a network that covers an area that ranges between dozens of square kilometers and thousands of square kilometers, such as the areas between a city and another city, and the areas between a country and another country. Furthermore, the network apparatus 4 is a hub, an access point (AP), a broadband router, or a router having at least one network interface function.

The network interface test device 2 comprises a control unit 6, a first port 8, a switch unit 10, and a plurality of second ports 12. The control unit 6 is connected to the switch unit 10. The control unit 6 is for use in generating and sending a control signal CS to the switch unit 10. The control signal CS is for use in controlling a router line inside the switch unit 10. The control unit 6 can be at least one of a single chip, a complex programmable logic device (CPLD), a digital signal processing (DSP), and a field programmable gate array (FPGA).

The first port 8 is connected to an external network test interface 14. The first port 8 receives a test packet signal TPS generated by the network test interface 14. The test packet signal TPS is a unitary unit for transmitting the basic information of a packet network. The test packet signal TPS comprises a control information and a user end data. In an embodiment of the present invention, the test packet signal TPS simulates a data transmission status in the Ethernet framework. The network test interface 14 executes the duty of the receipt and transmission of the test packet signal TPS; or, in other words, the network test interface 14 enables two-way data transmission. Also, the first port 8 and the network test interface 14 are provided with RJ45-compatible connectors, respectively, and are connected to each other by RJ45 jacks. The first port 8 and the network test interface 14 are adapted to transmit the test packet signal TPS.

The switch unit 10 is connected to the first port 8 and the control unit 6, and is equipped with router lines L1-L4 which can be switched to form a switching path P according to the control signal CS. For example, the control signal CS enables the node N1 to selectively point to one of the nodes N2-N5. If the control signal CS selects the connection of the node N1 and the node N2, the switching path P will be formed between the node N1 and the node N2. In an embodiment, the router lines L1-L4 can be implemented in the form of an integrated circuit (IC) of a matrix configuration. The integrated circuit provides the one-to-many switching path P as described in detail below.

The second ports 12 is connected to the switch unit 10 and connected to the network interfaces. Any one of the second ports 12 is electrically connected to the first port 8 via the switching path P, so as to enable the test packet signal TPS to be transmitted by the first port 8 to one of the network interfaces which is selected according to the switching path P. Hence, the test packet signal TPS is transmitted between the network test interface 14 and the network interfaces by means of the switching path P of the switch unit 10.

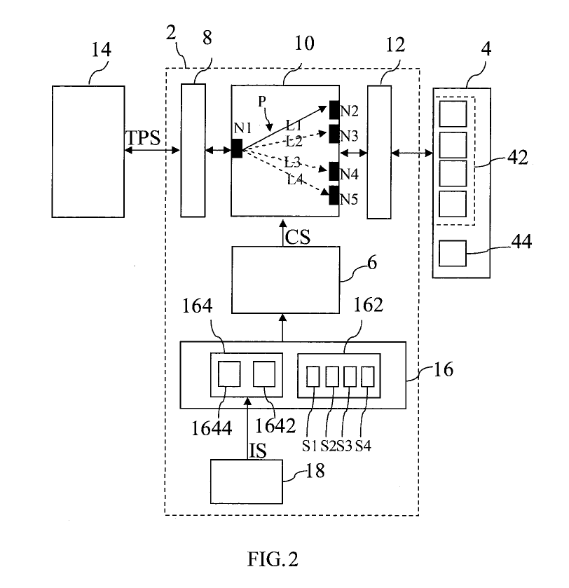

Referring to FIG. 2, there is shown a schematic view of the network interface test device 2 according to the second embodiment of the present invention. As shown in FIG. 2, the network interface test device 2 further comprises a controlling driving unit 16. The controlling driving unit 16 is connected to the control unit 6. The controlling driving unit 16 drives the control unit 6 to generate the control signal CS. The controlling driving unit 16 comprises at least one of an internal driving subunit 162 and an external connecting subunit 164. The internal driving subunit 162 comprises a plurality of control switches S1-S4. In an embodiment, the control switches S1-S4 are for selecting any one of the router lines L1-L4. For example, if the control switch S1 is selected, the router line L1 will also be selected. The aforesaid selection enables the switching path P to be connected to the node N1 of the first port 8 and the node N2 of the second ports 12, by using the router line L1 thus selected. Also, given the aforesaid way of control, it is feasible to connect the node N1 and the nodes N2-N5.

The external connecting subunit 164 is connected to an external terminal apparatus 18, such as a computer terminal, and is adapted to receive an instruction signal IS generated by the terminal apparatus 18. The instruction signal IS is similar to the control signal CS generated by the internal driving subunit 162, and thus the instruction signal IS can just be deemed as the control signal CS generated by the terminal apparatus 18. In addition, the external connecting subunit 164 is at least one of a parallel port 1642 and a serial port 1644; or, in other words, the terminal apparatus 18 transmits the instruction signal IS via the parallel port 1642 or the serial port 1644. For instance, the parallel port 1642 can be a printer port, and the serial port 1644 can be a RS-232 port.

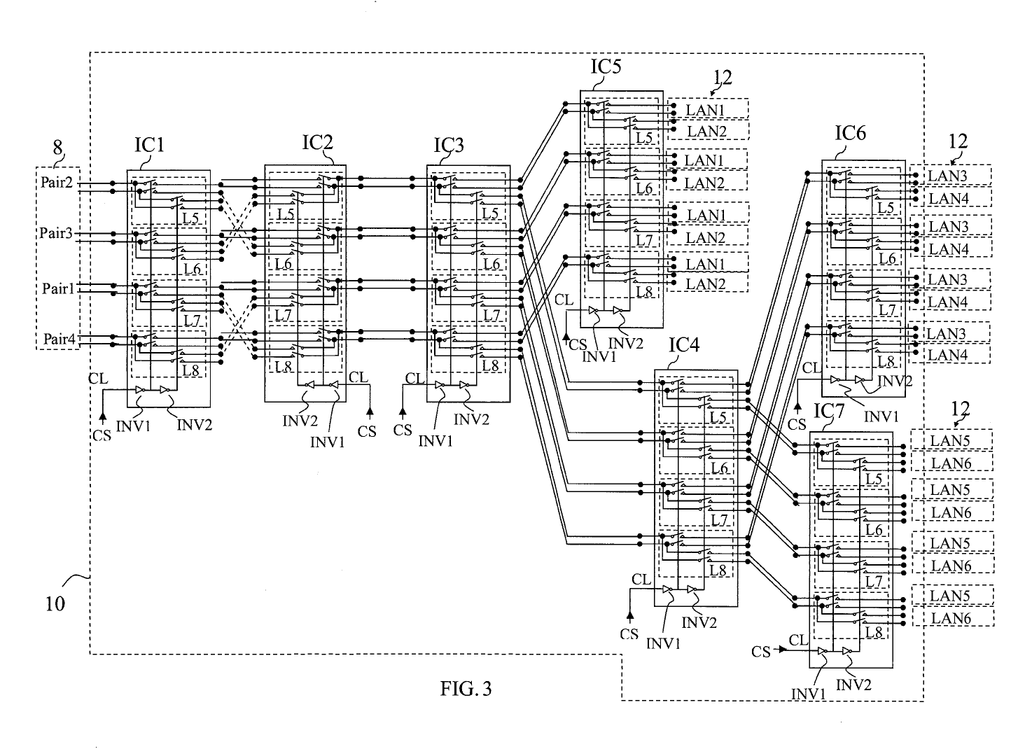

Referring to FIG. 3, there is shown FIG. 3 is a circuit diagram of the switch unit 10 of the network interface test device 2 according to the third embodiment of the present invention. As shown FIG. 3, the switch unit 10 comprises a plurality of integrated circuits IC1-IC7 having a matrix configuration. The switch unit 10 is connected to the RJ-45-compatible first port 8 and the second ports 12. The first port 8 and each of the second ports 12 enable the input of eight twisted pair wires, respectively, according to the RJ-45 arrangement. To be specific, pins governed by the RJ-45 specifications, namely pins pair 2, pins pair 3, pins pair 1, and pins pair 4 each comprises two twisted pair wires. The integrated circuits each further comprise a control line CL. The control line CL receives the control signal CS from the control unit. The control line CL can select any one of the router lines L5-L8 of any one of the integrated circuits, and can enable the pins pair 2, pins pair 3, pins pair 1, and pins pair 4 to select the switching path P. In an embodiment, the control line CL is connected to two inverters INV1, INV2 so as to implement any available one of the router lines L5-L8.

Due to the series-connection and parallel-connection of the integrated circuits IC1-IC7 and their respective control over the control line CL, the first port 8 can correspond to six second ports 12. The switching path P of the integrated circuits IC1-IC7 enables the first port 8 to be electrically connected to any one of the second ports 12 freely.

Take the integrated circuit IC1 and the integrated circuit IC2 as an example, it is feasible to change the router lines so as to conduct parallel or cross network tests directly. For example, as set forth in the RJ-45 specifications, it is feasible to provide the cross connection of the pins pair 2, pins pair 3, pins pair 1, and pins pair 4, so as to conduct cross network tests of the pins pair 2, pins pair 3, pins pair 1, and pins pair 4. By contrast, parallel network tests can be conducted, by keeping unchanged the pin positions of the pins pair 2, pins pair 3, pins pair 1, and pins pair 4.

For example, inputting the value 0 to the control line CL of the integrated circuit IC1, the value 0 to the control line CL of the integrated circuit IC2, the value 0 to the control line CL of the integrated circuit IC3, the value 0 to the control line CL of the integrated circuit IC4, the value 0 to the control line CL of the integrated circuit IC5, the value 0 to the control line CL of the integrated circuit IC6, and the value 0 to the control line CL of the integrated circuit IC7 results in selecting the local area network LAN1 and conducting parallel network tests. In another embodiment, inputting the value 0 to the control line CL of the integrated circuit IC1, the value 1 to the control line CL of the integrated circuit IC2, the value 0 to the control line CL of the integrated circuit IC3, the value 0 to the control line CL of the integrated circuit IC4, the value 0 to the control line CL of the integrated circuit IC5, the value 0 to the control line CL of the integrated circuit IC6, and the value 0 to the control line CL of the integrated circuit IC7 results in selecting the local area network LAN1 and conducting cross network tests.

Hence, according to the present invention, it is feasible to change the control line CL of any one of the integrated circuits IC1-IC7 in order to select one of the local area networks LAN2-LAN6 and conduct network tests.

The parallel or cross network tests not only take place between the integrated circuit IC1 and the integrated circuit IC2, but take place at the output ends of any one of the integrated circuits IC1-IC7.

Compared with the prior art, the present invention provides a network interface test device for testing a plurality of network interfaces of a network apparatus for use with Ethernet operating at a speed as high as 1 Gbit/s or more, to conduct a test of the transmission of packets conveyed between the network interfaces and an external network test interface by means of a wide area network (WAN) interface in the network interfaces so as to confirm whether the network interfaces meet the speed specifications set forth in IEEE 802.3 Ethernet (10BASE-T Ethernet) and express Ethernet (100BASE-T, 1000BASE-T Ethernet), and to conduct a test of the transmission of packets conveyed between one of the network interfaces and the network interfaces so as to confirm whether the functions of the network interfaces meet the Ethernet specifications.

In addition, a test circuit provided by the present invention enables a plurality of network interfaces to be tested by means of a single network test interface and a plurality of router lines in a switch circuit which is programmable planned such that, with the router lines being planned, the parallel or cross network tests can be easily conducted.

Hence, according to the present invention, a test can be conducted on network interfaces in accordance with express Ethernet specifications, and it is feasible to conduct an express network test stably without losing a packet in the course of the transmission thereof.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A network interface test device for testing a plurality of network interfaces of
a network apparatus, the network interface test device comprising:
a control unit for generating a control signal;
a first port connected to an external network test interface so as to receive a test packet signal generated by the network test interface;
a switch unit connected to the first port and the control unit and equipped with at least one router line switchable to form a switching path according to the control signal; and
a plurality of second ports connected to the switch unit and connected to the network interfaces, wherein any one of the second ports is electrically connected to the first port via the switching path to enable the test packet signal to be transmitted by the first port to one of the network interfaces which is selected according to the switching path.

2. The network interface test device of claim 1, further comprising a controlling driving unit connected to the control unit and adapted to drive the control unit to generate the control signal.

3. The network interface test device of claim 2, wherein the controlling driving unit further comprises at least one of an internal driving subunit and an external connecting subunit.

4. The network interface test device of claim 3, wherein the internal driving subunit comprises a plurality of control switches.

5. The network interface test device of claim 3, wherein the external connecting subunit is connected to an external terminal apparatus and adapted to receive a instruction signal generated by the terminal apparatus.

6. The network interface test device of claim 5, wherein the external connecting subunit is at least one of a parallel port and a serial port.

7. The network interface test device of claim 1, wherein the router line is an integrated circuit of a matrix configuration.

8. The network interface test device of claim 7, wherein the integrated circuit provides the one-to-many switching path.

9. The network interface test device of claim 1, wherein the first port and the second ports switch between the router lines to enable a parallel or cross network test to be conducted between the network test interface and the network interfaces.

10. The network interface test device of claim 1, wherein the control unit is at least one of a single chip, a complex programmable logic device (CPLD), a digital signal processing (DSP), and a field programmable gate array (FPGA).
